(19) United States
(12) Patent Application Publication
(10) Pub. No.: US 2024/0363880 A1
(43) Pub. Date: Oct. 31, 2024

(54) REDOX FLOW BATTERY

(71) Applicants: DENSO CORPORATION, Kariya-city (JP); WASEDA UNIVERSITY, Tokyo (JP)

(72) Inventors: Kan KITAGAWA, Kariya-city (JP); Ryota SHINOZAKI, Kariya-city (JP); Yuto IGARASHI, Tokyo (JP); Kan HATAKEYAMA, Tokyo (JP); Kenichi OYAIZU, Tokyo (JP)

(21) Appl. No.: 18/640,106

(22) Filed: Apr. 19, 2024

(30) Foreign Application Priority Data
Apr. 28, 2023 (JP) 2023-073953

(51) Int. Cl. H01M 8/18

(52) U.S. Cl. CPC H01M 8/188

(57) ABSTRACT

A redox flow battery includes a positive-side electrode tank that stores an electrolytic solution to be circulated to a positive electrode chamber in which a positive electrode is accommodated; and a negative-side electrode tank that stores an electrolytic solution to be circulated to a negative electrode chamber in which a negative electrode is accommodated. Each electrolytic solution contains an active material and a mediator, and the active material is solid in each electrolytic solution. An electrolyte concentration in each electrolytic solution is adjusted such that a potential difference between an equilibrium potential of the active material and an equilibrium potential of the mediator is equal to or less than a predetermined potential difference.

### CROSS REFERENCE TO RELATED APPLICATION

This application is based on and incorporates herein by reference Japanese Patent Application No. 2023-073953 filed on Apr. 28, 2023.

### TECHNICAL FIELD

The present disclosure relates to a redox flow battery.

### BACKGROUND

There is known a redox flow battery which includes a battery cell and an electrolytic solution tank in which an electrolytic solution containing an active material is stored. The electrolytic solution is circulated and supplied to the battery cell.

### SUMMARY

According to at least one embodiment of the present disclosure, a redox flow battery includes a redox flow battery cell, a positive-side electrode tank, and a negative-side electrode tank. The redox flow battery cell includes a positive electrode chamber that accommodates a positive electrode, a negative electrode chamber that accommodates a negative electrode, and a separator that partitions the positive electrode chamber and the negative electrode chamber. The positive-side electrode tank stores an electrolytic solution to be circulated to the positive electrode chamber. The negative-side electrode tank stores an electrolytic solution to be circulated to the negative electrode chamber. Each electrolytic solution contains an active material and a mediator. The active material is solid in each electrolytic solution. An equilibrium potential of the active material and an equilibrium potential of the mediator depend on an electrolyte concentration in each electrolytic solution. The electrolyte concentration in each electrolytic solution is adjusted such that a potential difference between the equilibrium potential of the active material and the equilibrium potential of the mediator is equal to or less than a predetermined potential difference.

### BRIEF DESCRIPTION OF THE DRAWINGS

The details of one or more embodiments are set forth in the accompanying drawings and the description below. Other features and advantages will be apparent from the description and drawings, and from the claims.

FIG. 1 is a conceptual diagram showing a redox flow battery according to an embodiment of the present invention.

FIG. 2 is a diagram showing a relationship between an equilibrium potential of a mediator and an equilibrium potential of an active material when an electrolyte concentration is changed.

### DETAILED DESCRIPTION

To begin with, examples of relevant techniques will be described. There is known a redox flow battery in the comparative example, which includes a battery cell and an electrolytic solution tank in which an electrolytic solution containing an active material is stored, in which the electrolytic solution is circulated and supplied to the battery cell.

A redox flow battery according to the comparative example has a configuration in which a solid active material is stored in a tank, a mediator contained in an electrolytic solution is circulated to a battery cell and an electrolytic solution tank, and energy transfer between the active material and the battery cell is mediated by the mediator. In the redox flow battery of the comparative example, with use of a polymer as the mediator, a mediator on a positive electrode side and a mediator on a negative electrode side can be prevented from being mixed with each other even when a porous membrane is used as a separator, and a low cost and a high output can be achieved. However, different mediators are used for charging and discharging in the comparative example. Therefore, a mediator concentration in the electrolytic solution is increased, and a viscosity of the electrolytic solution is increased. As a result, pump power for circulating the electrolytic solution may be increased.

In contrast, according to the present disclosure, a mediator concentration can be reduced in a redox flow battery in which a polymer is used as a mediator and a porous membrane is used as a separator.

According to an aspect of the present disclosure, a redox flow battery includes a redox flow battery cell, a positive-side electrode tank, and a negative-side electrode tank. The redox flow battery cell includes a positive electrode chamber that accommodates a positive electrode, a negative electrode chamber that accommodates a negative electrode, and a separator that partitions the positive electrode chamber and the negative electrode chamber. The positive-side electrode tank stores an electrolytic solution to be circulated to the positive electrode chamber. The negative-side electrode tank stores an electrolytic solution to be circulated to the negative electrode chamber. Each electrolytic solution contains an active material and a mediator. The active material is solid in each electrolytic solution. An equilibrium potential of the active material and an equilibrium potential of the mediator depend on an electrolyte concentration in each electrolytic solution. The electrolyte concentration in each electrolytic solution is adjusted such that a potential difference between the equilibrium potential of the active material and the equilibrium potential of the mediator is equal to or less than a predetermined potential difference.

Accordingly, one type of mediator can be used as both a charging mediator and a discharging mediator. Therefore, one type of mediator can be used as both the charging mediator and the discharging mediator by simple means of adjusting an electrolyte concentration in an electrolytic solution without changing a polymer structure of the mediator.

Embodiments of the present disclosure will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

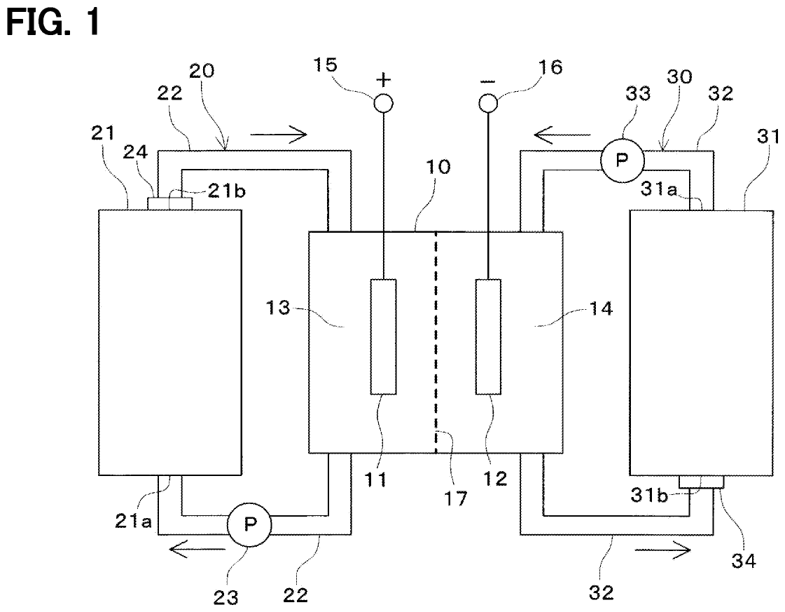

Hereinafter, an embodiment of the present disclosure will be described with reference to the drawings. A redox flow battery according to the present embodiment may be mounted in a moving object such as a vehicle and used for a moving object, or may be used for a stationary object. As shown in FIG. 1, the redox flow battery includes a battery cell 10, a first circulation mechanism 20, and a second circulation mechanism 30.

The battery cell 10 is a redox flow rechargeable battery, and performs charging and discharging by circulating an electrolytic solution to advance a redox reaction. The battery cell 10 includes a positive electrode chamber 13 that accommodates a positive electrode 11 and a negative electrode chamber 14 that accommodates a negative electrode 12. The positive electrode chamber 13 and the negative electrode chamber 14 can circulate an electrolytic solution supplied from the outside of the battery cell 10. The electrolytic solution contains carrier ions, an active material, and a mediator. An electrolytic solution to be supplied to the positive electrode chamber 13 is referred to as a positive electrode electrolytic solution and an electrolytic solution to be supplied to the negative electrode chamber 14 is referred to as a negative electrode electrolytic solution.

For example, an electron conductor having a large specific surface area, such as carbon felt, carbon paper, a carbon nanotube sheet, and a porous metal, can be used as the positive electrode 11 and the negative electrode 12. A positive electrode terminal 15 is connected to the positive electrode 11. A negative electrode terminal 16 is connected to the negative electrode 12. The positive electrode terminal 15 and the negative electrode terminal 16 are connected to a charging and discharging device (not shown). The charging and discharging device applies a voltage to the positive electrode 11 and the negative electrode 12 during charging of the battery cell 10, and extracts electric power from the positive electrode 11 and the negative electrode 12 during discharging of the battery cell 10.

A separator 17 that partitions the positive electrode chamber 13 and the negative electrode chamber 14 is provided inside the battery cell 10. The separator 17 separates the positive electrode chamber 13 from the negative electrode chamber 14. The separator 17 is a membrane-like porous body. The separator 17 has a large number of pores that connect the positive electrode chamber 13 to the negative electrode chamber 14.

A porous membrane such as a PP microporous membrane, a PE microporous membrane, or a nonwoven fabric separator can be used as the separator 17. For example, a product with a name “CELGARD” from Asahi Kasei Corporation can be used as the PP microporous membrane. For example, a product with a name “HIPORE” from Asahi Kasei Corporation can be used as the PE microporous membrane.

The first circulation mechanism 20 circulates an electrolytic solution into the positive electrode chamber 13 of the battery cell 10. The first circulation mechanism 20 includes a positive-side electrode tank 21, a positive-side electrode pipe 22, a positive-side electrode pump 23, and a positive-side electrode filter 24. The positive-side electrode tank 21 stores the positive electrode electrolytic solution.

The positive-side electrode tank 21 includes an inflow portion 21a through which an electrolytic solution flows in and an outflow portion 21b through which the electrolytic solution flows out. The positive electrode electrolytic solution in the positive-side electrode tank 21 is circulated to the positive electrode chamber 13 of the battery cell 10 through the positive-side electrode pipe 22.

The positive-side electrode pump 23 is provided in the positive-side electrode pipe 22 and pumps out the positive electrode electrolytic solution. The positive-side electrode filter 24 is provided in the outflow portion 21b of the positive-side electrode tank 21. The positive electrode electrolytic solution in the positive-side electrode tank 21 contains an active material, and the positive-side electrode filter 24 restricts an outflow of the active material from the positive-side electrode tank 21.

The second circulation mechanism 30 circulates an electrolytic solution into the negative electrode chamber 14 of the battery cell 10. The second circulation mechanism 30 includes a negative-side electrode tank 31, a negative-side electrode pipe 32, a negative-side electrode pump 33, and a negative-side electrode filter 34. The negative-side electrode tank 31 stores the negative electrode electrolytic solution.

The negative-side electrode tank 31 includes an inflow portion 31a through which an electrolytic solution flows in and an outflow portion 31b through which the electrolytic solution flows out. The negative electrode electrolytic solution in the negative-side electrode tank 31 is circulated to the negative electrode chamber 14 of the battery cell 10 through the negative-side electrode pipe 32.

The negative-side electrode pump 33 is provided in the negative-side electrode pipe 32 and pumps out the negative electrode electrolytic solution. The negative-side electrode filter 34 is provided in the outflow portion 31b of the negative-side electrode tank 31. The negative electrode electrolytic solution in the negative-side electrode tank 31 contains an active material, and the negative-side electrode filter 34 restricts an outflow of the active material from the negative-side electrode tank 31.

Here, the positive electrode electrolytic solution and the negative electrode electrolytic solution will be described. In the present embodiment, an electrolytic solution of the same type is used as the positive electrode electrolytic solution and the negative electrode electrolytic solution.

A solvent in the electrolytic solution may be a polar solvent, and examples thereof include water, propylene carbonate, ethylene carbonate, dimethyl carbonate, diethyl carbonate, acetonitrile, dimethyl sulfoxide (DMSO), diglyme, triglyme, and tetraglyme. In the present embodiment, water is used as the solvent in the electrolytic solution.

A salt containing a carrier ion can be used as an electrolyte in the electrolytic solution. Examples of the carrier ion include an ion having a charge such as Li⁺, Na⁺, K⁺, Mg²⁺, and Ca²⁺. In the present embodiment, Li⁺ is used as the carrier ion, and LiCl is used as the electrolyte. The separator 17 allows the carrier ion to move between the positive electrode chamber 13 and the negative electrode chamber 14.

Each of the positive electrode electrolytic solution and the negative electrode electrolytic solution contains an active material. The active material is a material capable of storing and releasing a carrier ion. The active material according to the present embodiment is a material that reacts with a mediator to store energy. The active material is solid in the electrolytic solution and is stored inside the tanks 21 and 31. The active material may be in a form of powder or pellets. In the present embodiment, a material capable of storing and releasing Li due to a potential change is used as the active material.

The active material according to the present embodiment is in a form of particles and has a particle diameter of 10 μm or more. Such an active material having a large particle diameter is likely to be in point contact with a mediator, and a reaction rate tends to be slow.

In the present embodiment, a ceramic active material having low electron conductivity is used. The electron conductivity of the ceramic active material used in the present embodiment is 10⁻⁵ S/cm or less. In such an active material having low electron conductivity, a rapid redox reaction is less likely to occur in all active material particles when the active material comes into contact with a mediator, and a reaction rate tends to be slow.

The positive electrode electrolytic solution contains a positive electrode active material, and the negative electrode electrolytic solution contains a negative electrode active material. Examples of the positive electrode active material include LiFePO₄ (LFP), LiMn₂O₄, LiNi_{0.5}Mn_{1.5}O₄, and LiMn_{0.8}Fe_{0.2}PO₄. Examples of the negative electrode active material include Li₄Ti₅O₁₂ (LTO) and TiO₂.

The positive electrode active material is present inside the positive-side electrode tank 21, and the negative electrode active material is present inside the negative-side electrode tank 31. As described above, an outflow of the positive electrode active material from the positive-side electrode tank 21 is restricted by the positive-side electrode filter 24. Therefore, the positive electrode active material is stored in the positive-side electrode tank 21 and is not supplied to the positive electrode chamber 13 of the battery cell 10. Similarly, an outflow of the negative electrode active material from the negative-side electrode tank 31 is restricted by the negative-side electrode filter 34. Therefore, the negative electrode active material is stored in the negative-side electrode tank 31 and is not supplied to the negative electrode chamber 14 of the battery cell 10.

The electrolytic solution contains a mediator having redox activity. The mediator according to the present embodiment contains dissolved particles dissolved in the electrolytic solution. The mediator is a redox medium that mediates electrons, and is a redox mediator that mediates another reaction through a redox reaction of the redox mediator.

A mediator contained in the positive electrode electrolytic solution can pass through the positive-side electrode filter 24. A mediator contained in the negative electrode electrolytic solution can pass through the negative-side electrode filter 34. Accordingly, the mediator is circulated through the battery cell 10 and the tanks 21 and 31, and can mediates energy transfer between the battery cell 10 and the active materials stored in the tanks 21 and 31.

The mediator according to the present embodiment is a polymer compound and has a diameter larger than a pore diameter of the separator 17. Therefore, the separator 17 restricts passage of the mediator and restricts movement of the mediator between the positive electrode chamber 13 and the negative electrode chamber 14.

In the present embodiment, a pore distribution d50 is used as the pore diameter of the separator 17. That is, the diameter of the mediator is larger than the pore distribution d50 of the separator.

The pore distribution shows a relationship between a pore diameter and a volume. The pore distribution of the separator 17 may be determined by, for example, an isothermal adsorption line measurement such as a BET method, or by directly observing a microscopic image such as an SEM image. The pore distribution d50 refers to a pore diameter when a volume is integrated from a pore having a small pore diameter in the pore distribution and the integrated volume reaches 50% of a total pore volume. That is, the pore distribution d50 refers to a pore diameter corresponding to a median value of the pore distribution.

The mediator according to the present embodiment is a dissolved polymer dissolved in the electrolytic solution, and a diameter of the mediator can be obtained based on a hydrodynamic radius. The hydrodynamic radius is expressed using a limiting viscosity number and a molecular weight. The limiting viscosity number is an increment in viscosity when one polymer is dissolved in an infinite solvent.

The positive electrode electrolytic solution contains a positive electrode mediator, and the negative electrode electrolytic solution contains a negative electrode mediator. Each of the positive electrode mediator and the negative electrode mediator includes a charging mediator used during the charging of the battery cell 10 and a discharging mediator used during the discharging of the battery cell 10.

The positive electrode mediator (the charging mediator and the discharging mediator) and the negative electrode mediator (the charging mediator and the discharging mediator) have no essential difference from each other, and are determined by a magnitude relationship of potentials between the mediator and the active material. Equilibrium potentials of the positive electrode active material, the negative electrode active material, the positive electrode mediator, and the negative electrode mediator have a relationship of negative electrode mediator (charging mediator)<negative electrode active material<negative electrode mediator (discharging mediator)<positive electrode mediator (discharging mediator)<positive electrode active material<positive electrode mediator (charging mediator).

The positive electrode mediator may be selected from mediators having an equilibrium potential corresponding to the equilibrium potential of the positive electrode active material. The negative electrode mediator may be selected from mediators having an equilibrium potential corresponding to the equilibrium potential of the negative electrode active material.

The charging mediator and the discharging mediator may be mediators having different equilibrium potentials. When one mediator has two equilibrium potentials, or when the equilibrium potential of the active material substantially overlaps the equilibrium potential of the mediator, one type of mediator may be used as both the charging mediator and the discharging mediator.

In the positive electrode mediator according to the present embodiment, one type of mediator is used as both the charging mediator and the discharging mediator. That is, the same mediator is used as the charging mediator and the discharging mediator in the positive electrode mediator.

In the present embodiment, the equilibrium potential of the positive electrode mediator and the equilibrium potential of the positive electrode active material are adjusted by adjusting an electrolyte concentration (a salt concentration) in the electrolytic solution, and a potential difference between the equilibrium potential of the positive electrode mediator and the equilibrium potential of the positive electrode active material is controlled to be equal to or less than a predetermined potential difference. This point will be described in detail later.

In the present embodiment, a polymer mediator that is a polymer compound having a main chain and a side chain is used as the mediator. The polymer mediator according to the present embodiment has a redox substituent and a polar group in the side chain. The redox substituent is a functional group capable of reversibly causing a redox reaction and having redox activity. The polar group is a functional group having polarity capable of increasing solubility in an electrolytic solution. The polymer mediator according to the present embodiment becomes a dissolved polymer dissolved in the electrolytic solution by introducing a polar group that improves the solubility in the electrolytic solution. In the present embodiment, the polymer mediator containing a redox substituent and a polar group is used as at least one of the positive electrode mediator and the negative electrode mediator.

The redox substituent contained in the polymer mediator is a functional group capable of reversibly causing a redox reaction. Examples of the redox substituent include a nitroxyl radical, a quinone derivative, a metallocene derivative, a carbazole derivative, an anthracene derivative, a diazole-based compound, a phenazine derivative, a disulfide, an aryl derivative, a phenothiazine derivative, a phenothiazine analog, and a derivative thereof. Examples of the phenothiazine analog include phenoxazine, phenazine, oxanthrene, thianthrene, acridine, xanthene, thioxanthene, and phenoxathiin.

The polar group contained in the polymer mediator is a functional group having polarity capable of increasing solubility in an electrolytic solution serving as a polar solvent. Examples of the polar group include a linear carbonate, a cyclic carbonate, imidazolium, an alkylammonium, trifluoromethanesulfonylimide, and fluorosphonylimide.

The polymer mediator according to the present embodiment is dissolved in the electrolytic solution, and a solvent is present around each side chain. A particle diameter of the polymer mediator dissolved in the electrolytic solution measured by using dynamic light scattering (DLS) is 100 nm or less.

In the present embodiment, the polymer mediator is a polymer compound having a bottle brush structure in which a macromonomer having a suspended redox substituent and polar group is polymerized in a main chain. The polymer compound having a bottle brush structure is a comb-shaped polymer in which a branched chain is introduced at a high density, and a redox substituent which is a redox active site and a polar group which is a site for improving solubility in an electrolytic solution are continuously arranged. The polymer compound having a bottle brush structure is easily dissolved in the electrolytic solution, and can reduce a viscosity of the electrolytic solution as compared with a linear polymer compound.

In the present embodiment, PQFcMA shown in the following structural formula is used as the polymer mediator used for the positive electrode mediator. In the following structural formula, x represents a copolymerization ratio.

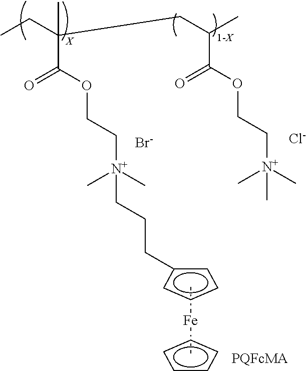

PQFcMA contains ferrocene as a redox substituent, and contains an alkylammonium and a carbonyl group as a polar group. The alkylammonium contains an ammonium group having high solubility in water. In PQFcMA, a first side chain containing an alkylammonium, a carbonyl group, and ferrocene and a second side chain containing an alkylammonium and a carbonyl group are continuously arranged. The first side chain and the second side chain have similar chemical structures except for the presence or absence of ferrocene.

Here, a method of synthesizing PQFcMA will be described.

First, BrPrFc and DMAEMA were mixed without using a solvent, followed by heating at 50° C. for 24 hours to obtain QFcMA as an intermediate (Scheme 1).

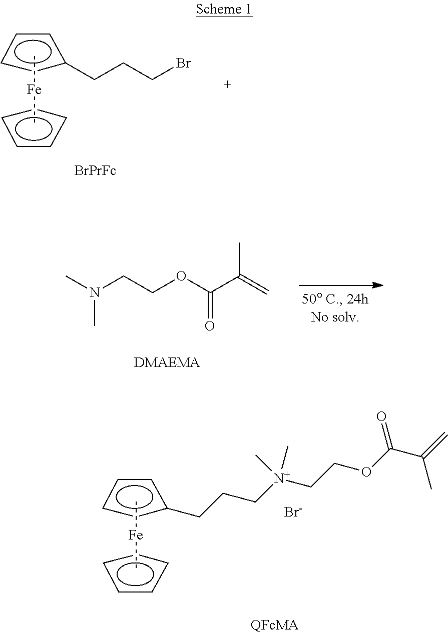

Subsequently, QFcMA and METAC were dissolved in a solvent at a predetermined charge ratio, and 4,4′-azobis(4-cyanovaleric acid) (ACVA) was added as a polymerization initiator to initiate radical polymerization. A mixture of methanol and water at a ratio of 3:1 was used as the solvent. Thereafter, ion exchange using an ion exchange resin was performed to obtain PQFcMA (Scheme 2). A chloride was used as counter ions of the ion exchange resin.

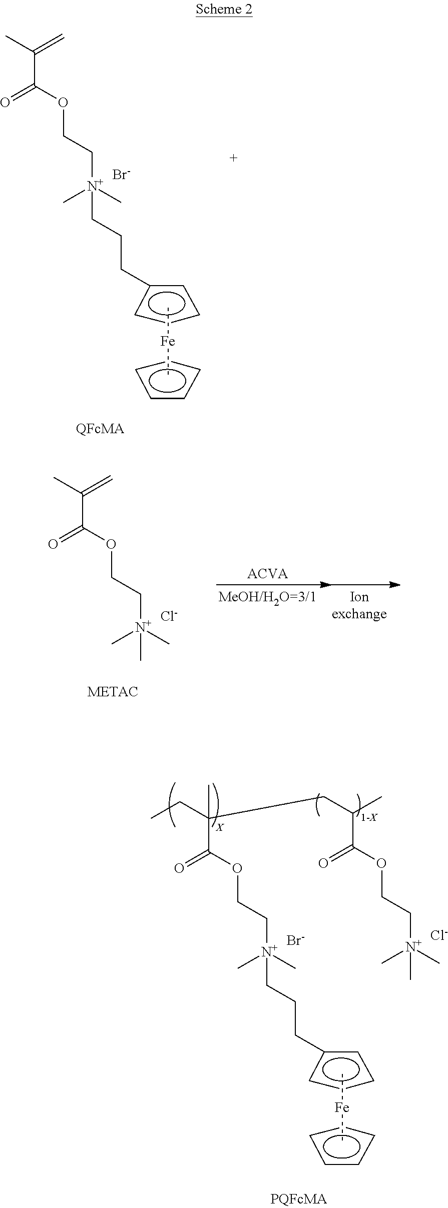

The copolymerization ratio x of PQFcMA can be adjusted by adjusting the charge ratio of QFcMA and METAC that are raw materials. In the present embodiment, METAC having a molecular structure close to that of a monomer QFcMA containing ferrocene is used as a comonomer. Accordingly, reactivity of the monomer containing ferrocene and reactivity of the comonomer can be brought close to each other, and a random copolymer PQFcMA in which the copolymerization ratio x is close to the charge ratio of the raw materials can be obtained.

Next, the equilibrium potential of the positive electrode mediator and the equilibrium potential of the positive electrode active material will be described. As described above, in the present embodiment, the equilibrium potential of the positive electrode mediator and the equilibrium potential of the positive electrode active material are adjusted by adjusting the electrolyte concentration (a salt concentration) in the electrolytic solution, and the potential difference between the equilibrium potential of the positive electrode mediator and the equilibrium potential of the positive electrode active material is set to be equal to or less than a predetermined potential difference.

When the potential difference between the equilibrium potential of the positive electrode mediator and the equilibrium potential of the positive electrode active material is large, it is difficult for charges to move during charging or discharging, and it is considered that only one of charging and discharging can be performed. Therefore, in order to use the positive electrode mediator as both the charging mediator and the discharging mediator, it is preferable that the potential difference between the equilibrium potential of the positive electrode mediator and the equilibrium potential of the positive electrode active material is as small as possible. The potential difference between the equilibrium potential of the positive electrode mediator and the equilibrium potential of the positive electrode active material may be set to be equal to or less than a potential difference at which the positive electrode mediator can be used as both the charging mediator and the discharging mediator, and in the present embodiment, the predetermined potential difference is 50 mV. More preferably, the predetermined potential difference is 35 mV.

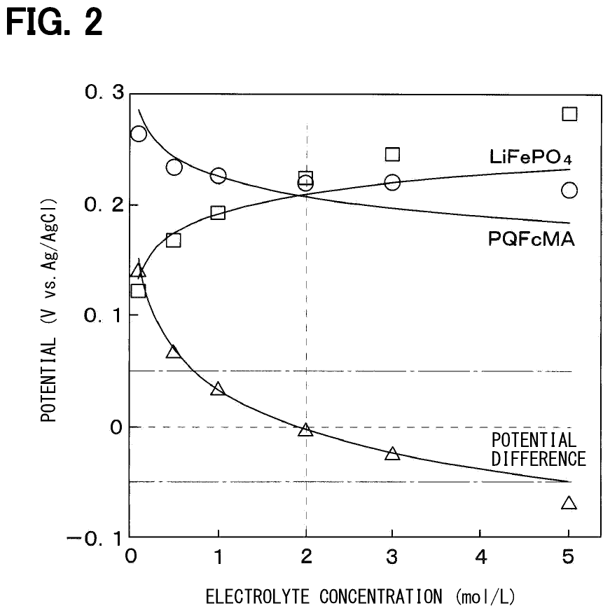

FIG. 2 shows the equilibrium potential of the positive electrode active material, the equilibrium potential of the positive electrode mediator, and the potential difference therebetween when the electrolyte concentration in the electrolytic solution is changed. LiCl is used as the electrolyte, PQFcMA is used as the positive electrode mediator, and LiFePO₄ (LFP) is used as the positive electrode active material. A chemical equivalent of PQFcMA is 1, and a chemical equivalent of LiFePO₄ is 10.

In the present embodiment, by changing the electrolyte concentration in the electrolytic solution, the equilibrium potential of the positive electrode active material and the equilibrium potential of the positive electrode mediator are changed in opposite directions and the potential difference between the equilibrium potential of the positive electrode mediator and the equilibrium potential of the positive electrode active material is set to be equal to or less than a predetermined potential difference.

In the present embodiment, the potential difference between the positive electrode active material and the positive electrode mediator is controlled by adjusting the electrolyte concentration using a fact that charges of ions compensated during a reaction between the positive electrode active material and the positive electrode mediator are opposite. As the electrolyte concentration increases, the equilibrium potential of one of the positive electrode active material and the positive electrode mediator increases, and the equilibrium potential of the other one decreases.

In the present embodiment, in a redox reaction, the positive electrode active material is cation-compensated and the mediator is anion-compensated. Therefore, when the electrolyte concentration in the electrolytic solution increases, the equilibrium potential of the positive electrode active material increases, and the equilibrium potential of the positive electrode mediator decreases. Hereinafter, this point will be described.

In general, the redox reaction can be expressed by the following half-reaction formula.

$$a A + b B + {ne}^{-} = xX + y Y$$

A redox potential of the reaction formula is expressed by the following Nernst equation.

$$E = {E}_{0} - RT / ( nF ) \cdot Ln \{ ( {[ X ]}^{x} \cdot {[ Y ]}^{y} ) / ( {[ A ]}^{a} \cdot {[ B ]}^{b} ) \}$$

According to the Nernst equation, the equilibrium potential increases as a concentration (activity) of a material (A, B) on a left side of the reaction formula increases, and the equilibrium potential decreases as a material (X, Y) on a right side of the reaction formula increases.

In the present embodiment, when the positive electrode active material and the positive electrode mediator undergo a redox reaction, one of the positive electrode active material and the positive electrode mediator is cation-compensated and the other one is anion-compensated. In the cation compensation, a charge compensation is performed by cations (Li⁺), and the equilibrium potential increases as the electrolyte concentration increases. In the anion compensation, a charge compensation is performed by anions (Cl⁻), and the equilibrium potential decreases as the electrolyte concentration increases.

The half-reaction formula of the redox reaction between the positive electrode active material and the positive electrode mediator according to the present embodiment is shown below. LiFePO₄ is a positive electrode active material, and Fc is ferrocene as a redox substituent contained in the positive electrode mediator PQFcMA.
Positive electrode active material: FePO₄+Li⁺+e⁻→LiFePO₄
Positive electrode mediator: Fc⁺Cl⁻+e⁻→Fc+Cl⁻

In the reaction formula of the positive electrode active material, when FePO₄ is reduced, a cation compensation is performed in which Li⁺ (cation) compensates charges. On the other hand, in the reaction formula of the positive electrode mediator, when Fc⁺ is reduced, an anion compensation is performed in which Cl⁻ (anion) compensates charges.

When a concentration of the electrolyte LiCl in the electrolytic solution increases, concentrations of Li⁺ and Cl⁻ increase. Since Li⁺ is on a left side of the reaction formula of the positive electrode active material, the equilibrium potential increases as the electrolyte concentration increases. On the other hand, since Cl⁻ is on a right side of the reaction formula of the positive electrode mediator, the equilibrium potential decreases as the electrolyte concentration increases.

In the example shown in FIG. 2, as the electrolyte concentration increases, the equilibrium potential of the positive electrode mediator decreases, and the equilibrium potential of the positive electrode active material increases. When the electrolyte concentration is around 2 mol/L, the equilibrium potential of the positive electrode active material and the equilibrium potential of the positive electrode mediator intersect with each other, and the potential difference is minimized.

In FIG. 2, a portion interposed between two one-dot chain lines indicates a range in which the potential difference between the equilibrium potential of the positive electrode mediator and the equilibrium potential of the positive electrode active material is 50 mV or less. In the example shown in FIG. 2, when the electrolyte concentration is 1 mol/L, 2 mol/L, and 3 mol/L, the potential difference between the equilibrium potential of the positive electrode active material and the equilibrium potential of the positive electrode mediator is 50 mV or less.

It is found that, when the electrolyte concentration is 1 mol/L, 2 mol/L, and 3 mol/L, the positive electrode mediator can be used as both the charging mediator and the discharging mediator. As described above, by appropriately controlling the electrolyte concentration such that the potential difference between the equilibrium potentials of the mediator and the active material is equal to or less than a predetermined potential difference, good reactivity can be obtained, and a mediator can be used as both the charging mediator and the discharging mediator.

Here, cases where the electrolyte concentration is 1 mol/L, 2 mol/L, and 3 mol/L will be described. Table 1 shows a battery capacity, Coulomb efficiency, an electrolyte concentration, and an equilibrium potential of the redox flow battery.

TABLE 1

| | | | Capacity (mAh) | | | Coulombic | Electrolyte | | |
|---|---|---|---|---|---|---|---|---|---|
| | Chemical Equivalent | | | | Theoretical | Efficiency | Concentration | E_{1/2} (V vs. Ag/AgCl) | |
| | PQFcMA | LiFePO₄ | Charging | Discharging | Value | (%) | (mol/L) | PQFcMA | LiFePO₄ |
| 1 | 1 | 10 | 0.857 | 0.786 | 2.2 | 92 | 1 | 0.226 | 0.192 |
| 2 | 1 | 10 | 0.608 | 0.600 | 2.2 | 99 | 2 | 0.220 | 0.224 |
| 3 | 1 | 10 | 0.386 | 0.386 | 2.2 | 100 | 3 | 0.221 | 0.246 |

As shown in Table 1, when the electrolyte concentration is 1 mol/L, the equilibrium potential of PQFcMA is 0.226 V, the equilibrium potential of LifePO₄ is 0.192 V, and the potential difference is 34 mV. When the electrolyte concentration is 1 mol/L, the equilibrium potential of PQFcMA is higher than that of LifePO₄. This state is advantageous for charging and disadvantageous for discharging. Therefore, a charging capacity increases, and a discharging capacity decreases.

When the electrolyte concentration is 3 mol/L, the equilibrium potential of PQFcMA is 0.221 V, the equilibrium potential of LifePO₄ is 0.246 V, and the potential difference is 25 mV. When the electrolyte concentration is 3 mol/L, the equilibrium potential of LifePO₄ is higher than that of PQFcMA. This state is advantageous for discharging and disadvantageous for charging. Therefore, the charging capacity is reduced. On the other hand, since the discharging capacity is large relative to the charging capacity, Coulomb efficiency is increased.

When the electrolyte concentration is 2 mol/L, the equilibrium potential of PQFcMA is 0.220 V, the equilibrium potential of LifePO₄ is 0.224 V, and the potential difference is 4 mV. When the electrolyte concentration is 2 mol/L, the equilibrium potentials of PQFcMA and LiFePO₄ are substantially equal to each other, and the potential difference between the equilibrium potentials of PQFcMA and LiFePO₄ is very small. This state is advantageous for both charging and discharging, and both the charging capacity and the discharging capacity are large.

In the present embodiment described above, the potential difference between the equilibrium potential of the mediator and the equilibrium potential of the active material is controlled to be equal to or less than a predetermined potential difference by adjusting the electrolyte concentration in the electrolytic solution. Accordingly, one type of mediator can be used as both the charging mediator and the discharging mediator. According to the present embodiment, one type of mediator can be used as both the charging mediator and the discharging mediator by simple means of adjusting the electrolyte concentration in the electrolytic solution without changing a polymer structure of the mediator.

Since one type of mediator can be used as both the charging mediator and the discharging mediator, a mediator concentration in the electrolytic solution can be reduced, a viscosity of the electrolytic solution can be reduced, and pump power for circulating the electrolytic solution can be reduced.

In the present embodiment, a polymer mediator is used. The polymer mediator tends to be in a form of particles, and tends to become dispersed particles in the electrolytic solution. When the polymer mediator becomes dispersed particles, a reaction between the active material and the mediator occurs at a site where the active material and the mediator are in point contact with each other, and thus a rapid redox reaction is less likely to occur in the entire active material, and a reaction rate tends to be slow. As a result, a charge and discharge rate of the redox flow battery is slow, leading to a decrease in battery capacity. This is particularly remarkable when a particle diameter of the active material is large and the electron conductivity of the active material is low.

In contrast, a polymer mediator containing a redox substituent and a polar group in a side chain is used in the present embodiment. In the polymer mediator according to the present embodiment, the solubility in the electrolytic solution is improved by the polar group to make the polymer mediator become a dissolved polymer, and the dissolved polymer can come into surface contact with the active material. Therefore, the polymer mediator according to the present embodiment can increase the reaction rate with the active material as compared with a case of using a polymer mediator dispersed in the electrolytic solution. As a result, the charge and discharge rate of the redox flow battery is increased, and accordingly, the battery capacity can be increased.

In the present embodiment, PQFcMA is used as the positive electrode mediator. PQFcMA contains an alkylammonium as a polar group. An ammonium group having an ionic site has solubility in water higher than that of an ether group. Therefore, in the positive electrode mediator according to the present embodiment, the solubility in the electrolytic solution using water as a solvent can be improved as compared with a mediator using, for example, an ether group as a polar group. Accordingly, the reaction rate between the mediator and the active material can be further increased, the charge and discharge rate of the redox flow battery can be increased, and the battery capacity can be increased.

In the present embodiment, water is used as the solvent of the electrolytic solution. Water is a preferable polar solvent from the viewpoint of the viscosity, safety, cost, and the like, but water has a narrow potential window and is likely to be unstable depending on a mediator or active material to be used. In contrast, in the positive electrode mediator and the positive electrode active material according to the present embodiment, water is stable, and water can be suitably used as the solvent of the electrolytic solution.

According to the polymer mediator in the present embodiment that improves the solubility in the electrolytic solution, even when an active material having a large particle diameter of 10 μm or more is used, the polymer mediator can be effectively brought into surface contact with the active material, and the reaction rate with the active material can be increased.

According to the polymer mediator in the present embodiment that improves the solubility in the electrolytic solution, even when an active material having low electron conductivity of 10⁻⁵ S/cm or less is used, the polymer mediator can be effectively brought into surface contact with the active material, and the reaction rate with the active material can be increased.

According to the present embodiment, a polymer compound is used as the mediator, and a diameter of the mediator is set to be larger than the pore diameter of the separator 17. Accordingly, even when a porous membrane is used as the separator 17, the positive electrode mediator and the negative electrode mediator can be prevented from mixing with each other.

It is possible to increase ion conductivity by using a porous membrane as the separator 17 as compared with a case of using an electrolyte membrane as the separator. Accordingly, an output density of the redox flow battery can be increased. This is particularly effective in a case where the redox flow battery is used in a moving object in which a mounting space is limited.

In the redox flow battery using a mediator, energy is transferred by bringing the mediator and the active material into contact with each other in the tanks 21 and 31. When a low molecule is used as the mediator, only the molecule in contact with the active material reacts with the active material, and the reaction rate is slow. In contrast, in a polymer compound used as the mediator in the present embodiment, active sites where a redox reaction is possible are concentrated to have a high density. Therefore, the reaction rate can be increased by simultaneously reacting the entire polymer compound.

In the present embodiment, a polymer compound having a bottle brush structure is used as the mediator. In the polymer compound having a bottle brush structure, active sites are continuously arranged, and a chain reaction is likely to occur. Therefore, the reaction rate can be increased.

The present disclosure is not limited to the embodiment described above, and various modifications can be made thereto as follows without departing from the spirit of the present disclosure. Means disclosed in the embodiment described above may be appropriately combined in an implementable range.

For example, although the redox flow battery is configured such that the electrolytic solution is circulated and supplied to both the positive electrode 11 and the negative electrode 12 of the battery cell 10 in the embodiment described above, the present disclosure is not limited thereto. The redox flow battery may be configured such that the electrolytic solution is circulated and supplied to any one of the positive electrode 11 and the negative electrode 12 of the battery cell 10. In this case, the other electrode of the positive electrode 11 and the negative electrode 12 may be configured as in a lithium ion battery.

Although an example is described in the embodiment described above in which LiFePO₄ is used as the positive electrode active material and PQFcMA is used as the positive electrode mediator, the present disclosure is not limited to this combination. Any combination of the active material and the mediator can be used as along as equilibrium potentials are changed in opposite directions by adjusting the electrolyte concentration and the potential difference is equal to or less than a predetermined potential difference.

Although the positive electrode mediator is used as both the charging mediator and the discharging mediator in the embodiment described above, the negative electrode mediator may be used as both the charging mediator and the discharging mediator. In this case, an electrolyte concentration (a salt concentration) in the electrolytic solution may be adjusted such that a potential difference between an equilibrium potential of the negative electrode mediator and an equilibrium potential of the negative electrode active material is equal to or less than a predetermined potential difference (for example, 50 mV or less).

Although an example is described in the embodiment described above in which the equilibrium potential of the active material increases and the equilibrium potential of the mediator decreases as the electrolyte concentration increases, the equilibrium potential of the active material may decrease and the equilibrium potential of the mediator may increase as the electrolyte concentration increases. That is, as the electrolyte concentration increases, one of the active material and the mediator may have a higher equilibrium potential due to a cation compensation, and the other one may have a lower equilibrium potential due to an anion compensation.

Although the polymer mediator in which a side chain containing only a polar group and a side chain containing a redox substituent and a polar group are combined is described in the embodiment described above, any polymer mediator may be used as along as the polymer mediator contains a polar group and a redox substituent. For example, a polymer mediator in which a side chain containing only a redox substituent and a side chain containing only a polar group are combined may be used, or a polymer mediator including only a side chain containing a redox substituent and a polar group may be used.

Although the polymer mediator is applied to the charging mediator of the positive electrode mediator in the embodiment described above, the present disclosure is not limited thereto. The polymer mediator may be applied to the discharging mediator of the positive electrode mediator, and the charging mediator or the discharging mediator of the negative electrode mediator.

While the present disclosure has been described with reference to various exemplary embodiments thereof, it is to be understood that the disclosure is not limited to the disclosed embodiments and constructions. To the contrary, the disclosure is intended to cover various modifications and equivalent arrangements. In addition, while the various elements of the disclosure are shown in various combinations and configurations, which are exemplary, other various combinations and configurations, including more, less or only a single element, are also within the spirit of the disclosure.

What is claimed is:

1. A redox flow battery comprising:
a redox flow battery cell including a positive electrode chamber that accommodates a positive electrode, a negative electrode chamber that accommodates a negative electrode, and a separator that partitions the positive electrode chamber and the negative electrode chamber;
a positive-side electrode tank that stores an electrolytic solution to be circulated to the positive electrode chamber; and
a negative-side electrode tank that stores an electrolytic solution to be circulated to the negative electrode chamber, wherein
each electrolytic solution contains an active material and a mediator,
the active material is solid in each electrolytic solution,
an equilibrium potential of the active material and an equilibrium potential of the mediator depend on an electrolyte concentration in each electrolytic solution, and
the electrolyte concentration in each electrolytic solution is adjusted such that a potential difference between the equilibrium potential of the active material and the equilibrium potential of the mediator is equal to or less than a predetermined potential difference.

2. The redox flow battery according to claim 1, wherein
one of the active material and the mediator increases in equilibrium potential, and the other one of the active material and the mediator decreases in equilibrium potential, in accordance with increase in electrolyte concentration in each electrolytic solution.

3. The redox flow battery according to claim 1, wherein
the predetermined potential difference is 50 mV.
